(19) United States
(12) Patent Application Publication
(10) Pub. No.: US 2025/0164830 A1
(43) Pub. Date: May 22, 2025

(54) DEVICE AND METHOD FOR TUNING THE POLARIZATION OF TWO OR MORE BEAMS FOR WAVELENGTH DIVISION MULTIPLEXING

(71) Applicant: HUAWEI TECHNOLOGIES CO., LTD., Shenzhen (CN)

(72) Inventors: Youxi Lin, Wuhan (CN); Talha Rahman, Munich (DE); Maxim Kuschnerov, Munich (DE); Zhiwei Li, Wuhan (CN); Rongfang Huang, Dongguan (CN)

(73) Assignee: HUAWEI TECHNOLOGIES CO., LTD., Shenzhen (CN)

(21) Appl. No.: 19/023,080

(22) Filed: Jan. 15, 2025

Related U.S. Application Data
(63) Continuation of application No. PCT/CN2022/121145, filed on Sep. 24, 2022.

(51) Int. Cl. G02F 1/09; G02F 1/01

(52) U.S. Cl. CPC G02F 1/09; G02F 1/0136

(57) ABSTRACT

The disclosure relates to an optical device for wavelength division multiplexing of two or more input beams. The disclosure proposes the optical device, and a corresponding method for operating the optical device. The optical device comprises a multiplexer and two or more channels for the two or more input beams, wherein each channel is configured to receive one input beam of the two or more input beams and to provide a rotated beam, which has a polarization rotated compared to a polarization of the corresponding input beam, to the multiplexer, and wherein at least one channel of the two or more channels is configured to rotate the polarization of the corresponding input beam in a different direction than at least one other channel of the two or more channels.

### CROSS-REFERENCE TO RELATED APPLICATIONS

This application is a continuation of International Application No. PCT/CN2022/121145, filed on Sep. 24, 2022, the disclosure of which is hereby incorporated by reference in its entirety.

### TECHNICAL FIELD

The disclosure relates to an optical device for wavelength division multiplexing of two or more input beams. The disclosure proposes the optical device, and a corresponding method for operating the optical device. The optical device comprises a multiplexer and two or more channels, wherein the two or more channels comprise means for individually rotating the polarization of the two or more input beams.

### BACKGROUND

Intensity modulated direct detection (IM-DD) techniques are conventionally used in data center networks (DCNs) as a cost and power effective optical interface solution. However, with the data rate increasing, and advanced modulation formats being used, IM-DD based implementations start to suffer from fiber related impairment penalties. For example, the four-wave-mixing (FWM) penalty arises in wavelength division multiplexing (WDM) systems, where the wavelength is close to the zero dispersion region of the fiber. The generated idler frequency causes cross-talk with the input signals and gives rise to a penalty in the transmission system. Since the FWM generated signal is proportional to the cubic power of the input signals, the higher the input power of the input signals, the larger the FWM penalty is. Thus, the FWM prevents increases of input power to further increase the link budget of the system. As a result, the FWM impairs optical systems to reach a high link budget.

Conventional WDM systems comprise two or more channels, wherein each channel corresponds to a central wavelength of a respective beam transmitted through said channel. For setting a state of polarization (SOP), for example a perpendicular SOP between neighbouring channels, conventional devices require an additional polarization combiner in the system which increases the cost. Further, conventional devices may comprise additional polarization control for each channel, for example differently polarized transmitters, and additional isolation to prevent reflected signals from influencing a corresponding fiber, which increases the complexity of the device design.

### SUMMARY

In view of the above, this disclosure aims to improve the flexibility of adjusting the polarization of input beams for supporting multiplexing. For example, an objective may be to reduce four-wave-mixing during wavelength division multiplexing. Further, an objective may be to reduce the complexity and/or costs of an optical device configured to perform wavelength division multiplexing and/or polarization division multiplexing.

These and other objectives are achieved by this disclosure as described in the enclosed independent claims. Advantageous implementations are further described in the dependent claims.

The disclosure may be based on the following consideration. FWM is sensitive to the SOP of the input signals. For example, when the SOP between neighbouring channels is perpendicular with respect to each other, the FWM penalty can be significantly reduced.

A first aspect of this disclosure provides an optical device for wavelength division multiplexing of two or more input beams, wherein the optical device comprises a multiplexer and two or more channels for the two or more input beams, wherein each channel is configured to receive one input beam of the two or more input beams and to provide a rotated beam, which has a polarization rotated compared to a polarization of the corresponding input beam, to the multiplexer, and wherein at least one channel of the two or more channels is configured to rotate the polarization of the corresponding input beam in a different direction than at least one other channel of the two or more channels.

The SOP of a respective beam of each channel, for example one input beam of the two or more input beams, may be individually tuned to an arbitrary angle.

Each channel may correspond to one beam referred to as a “respective beam of the channel”. Each channel may only comprise the respective beam of the channel. For each channel, the respective beam of the channel may be modified by the channel. For example, the polarization of the respective beam of the channel may be rotated and/or the respective beam of the channel may be attenuated by a linear polarizer. The rotated beam may be based on the input beam and may be the variant of the respective beam of the channel that is provided to the multiplexer.

The optical device may enable arbitrary polarization division multiplexing and wavelength division multiplexing at the same time, wherein the costs and/or complexity of the optical device may be reduced compared to conventional devices.

The optical device may be used for any IM-DD WDM based optical system, for example, an optical module connected to router, a switch, or any type of host board having optical module interfaces.

In an implementation form of the first aspect, each channel comprises an optical isolator segment configured to restrict the optical transmission through the channel to a direction towards the multiplexer.

The optical device may have feedback tolerance of each channel and arbitrary polarization multiplexing at the same time. The optical isolator segment may prevent backward reflections of the respective beam of the channel.

Polarization interleaving may be realized by placing, for each channel, the isolator segment in front of the output of the channel before the multiplexer.

Each isolator segment may not add insertion loss. Each optical isolator segment may comprise an optical isolator, for example, a conventional optical isolator or an optical diode.

The optical device may comprise N channels and the two or more input signals may be N input signals, wherein N is a positive integer larger than 1.

The rotated beams provided by the two or more channels may be two or more rotated beams.

In a further implementation form of the first aspect, for each channel, the optical isolator segment comprises a rotator segment configured to rotate the polarization of a respective beam of the channel, and wherein, for at least one channel, the rotator segment is configured to rotate the respective beam of the channel in a different direction than the rotator segment of at least one other channel of the two or more channels.

The respective beam of the channel may be based on the input beam of the channel. For example, the respective beam of the channel may be the input beam of the channel or a modified input beam that was modified by other segments of the channel.

The rotator segment may be a first rotator segment.

The optical device may comprise N first rotator segments.

In a further implementation form of the first aspect, each optical isolator segment comprises a first polarizer segment and a second polarizer segment, wherein, for each channel, the rotator segment is positioned between the first polarizer segment and the second polarizer segment, and wherein the second polarizer segment is positioned between the rotator segment and the multiplexer, wherein, for each channel, the rotator segment is configured to rotate the polarization of the respective beam of the channel to form a first rotated beam, wherein each first polarizer segment comprises a linear polarizer configured to primarily transmit beams of a first polarization direction, and wherein each second polarizer segment comprises a linear polarizer configured to primarily transmit beams with a polarization of the respective first rotated beam of the channel.

The first rotated beam may be the rotated beam provided to the multiplexer.

For each channel, the linear polarizer of the first polarizer segment may be a first linear polarizer and the linear polarizer of the second polarizer segment may be a second linear polarizer.

Each linear polarizer may be configured to primarily transmit beams with a SOP that is matching a respective angle of orientation of the linear polarizer but may also transmit beams with different SOPs. The beams with a SOP that are matching a respective angle of orientation of the linear polarizer may be attenuated the least compared to beams with different SOPs.

The first polarization direction of every channel may be equal. For each channel, the first polarization direction may be equal to a polarization direction of the input beam of the channel.

In a further implementation form of the first aspect, each channel further comprises a second rotator segment, wherein the second rotator segment is positioned between the multiplexer and the optical isolator segment, and wherein the second rotator segment is configured to rotate the polarization of the respective beam of the channel, for example, after the polarization of the respective beam of the channel was rotated by the first rotator segment.

In a further implementation form of the first aspect, for each channel, the respective first rotated beam is the rotated beam provided by the channel, or wherein, for each channel, the second rotator segment is configured to rotate the polarization of the respective beam of the channel to form a second rotated beam, and wherein, for each channel, the respective second rotated beam is the rotated beam provided by the channel.

In a further implementation form of the first aspect, each channel further comprises a third rotator segment, wherein the optical isolator segment is positioned between the third rotator segment and the multiplexer, and wherein the third rotator segment is configured to rotate the polarization of the respective beam of the channel, for example, before the polarization of the respective beam of the channel is rotated by the first rotator segment, into the first polarization direction, for example, to form a third rotated beam.

Thus, for each channel, the SOP of the third rotated beam may match the angle of polarization of the first polarizer segment and/or may match an input polarization angle of the isolator segment.

The input beam of each channel may be considered “modified” by the third rotator segment. Thus, the isolator segment of the channel may receive the respective beam of the channel that is considered to be a “modified” input beam or the respective beam of the channel based on the input beam.

The input beam of each channel may be considered “modified” by other segments that are positioned before the isolator segment. Thus, the isolator segment of the channel may receive the respective beam of the channel that is considered to be a “modified” input beam or the respective beam of the channel based on the input beam.

The term “positioned before” may refer to a segment of a channel that is configured to receive the respective beam of the channel before a respective other segment of the channel during the process of the channel receiving one input beam and providing a rotated beam to the multiplexer.

In a further implementation form of the first aspect, the two or more input beams have a same polarization.

In a further implementation form of the first aspect, each input beam of the two or more input beams has a different central wavelength.

In a further implementation form of the first aspect, each channel is associated with a central wavelength of the corresponding input beam of the channel, wherein each channel forms an adjacent channel with one or two other channels that is associated with an input beam with a next larger or next smaller central wavelength of the two or more input beams.

The two or more channels may comprise two channels that form, respectively, only one adjacent channel with the two or more other channels. The other channels of the two or more channels may form respectively two adjacent channels with the two or more other channels.

For each channel, if the two or more channels comprise only one other channel that fulfils one of the conditions of being associated with an input beam with a next larger wavelength or an input beam with a next smaller wavelength than the input beam associated with the channel, then the channel forms only one adjacent channel with said other channel.

For each channel, if the two or more channels comprise two other channels that fulfil one of the conditions of being associated with an input beam with a next larger wavelength or an input beam with a next smaller wavelength than the input beam associated with the channel, then the channel forms two adjacent channels with said two other channels.

In a further implementation form of the first aspect, each channel is configured to rotate the polarization of the corresponding input beam in a different direction than the one or two adjacent channels of the channel.

In a further implementation form of the first aspect, for each channel, the rotator segment is configured to rotate the polarization of the respective beam of the channel in a different direction than the rotator segment of the one or two adjacent channels of the channel.

In a further implementation form of the first aspect each channel is configured to rotate the polarization of the corresponding input beam in a different direction than the one or two adjacent channels of the channel such that the respective rotated beams provided by adjacent channels have orthogonal polarizations to each other.

In a further implementation form of the first aspect, for each channel, the rotator segment is configured to rotate the polarization of the respective beam of the channel in a different direction than the rotator segment of the one or two adjacent channels of the channel such that the respective rotated beams provided by adjacent channels have orthogonal polarizations to each other.

For example, the four-wave-mixing outrage possibility may be reduced, as the respective rotated beams provided by adjacent channels have orthogonal polarizations to each other.

In a further implementation form of the first aspect, each channel is configured to rotate the polarization of the corresponding input beam by a same absolute amount but in a different direction than the one or two adjacent channels of the channel.

In a further implementation form of the first aspect, for each channel, the rotator segment is configured to rotate the polarization of the respective beam of the channel by a same absolute amount but in a different direction than the rotator segment of the one or two adjacent channels of the channel.

In a further implementation form of the first aspect, each channel is configured to rotate the polarization of the corresponding input beam by 45° in a first plane and the one or two adjacent channels of the channel are configured to rotate the polarization of the corresponding input beam by −45° in the first plane.

In a further implementation form of the first aspect, for each channel, the rotator segment is configured to rotate the polarization of the respective beam of the channel by 45° in a first plane and rotator segments of the one or two adjacent channels of the channel are configured to rotate the polarization of the respective beam of the channel by −45° in the first plane.

Thus, the optical isolator segment may prevent backward reflections of the respective beam of the channel by a maximum amount. For example, the optical isolation may be maximized.

In a further implementation form of the first aspect, for each channel, the rotator segment of the optical isolator segment is configured to rotate the polarization of the respective beam of the channel by a maximum absolute amount that fulfils the condition that the respective rotated beams provided by adjacent channels are orthogonal to each other.

For example, a polarization rotation of 45° and −45° in the optical isolator may be beneficial, as said rotation would lead to the maximum isolation. However, as other optical components may be configured to modify the respective beam of the channel and/or be positioned after the rotator segment, the maximum absolute amount that fulfils the condition that the respective rotated beams provided by adjacent channels are orthogonal to each other may deviate from 45°, wherein a maximum absolute of polarization rotation may maximize the isolation.

In a further implementation form of the first aspect, each channel is configured to rotate the polarization of the corresponding input beam into a second direction that is orthogonal to a third direction, and wherein the third direction is the direction of polarization of the respective rotated beams provided by the one or two adjacent channels of the channel.

The second direction of a first channel of the two or more channels may be different than the second direction of another channel of the two or more channels.

The third direction of a first channel of the two or more channels may be different than the third direction of another channel of the two or more channels.

The SOPs of each channel may be individually tuned.

In a further implementation form of the first aspect, each rotated beam provided by the two or more channels to the multiplexer is either of a fourth polarization or a fifth polarization, wherein the fourth polarization is orthogonal to the fifth polarization.

The two or more rotated beams may comprise beams of only two different SOPs.

In a further implementation form of the first aspect, the two or more channels comprise a first set of channels and a second set of channels, wherein each channel in the first set of channels is an adjacent channel to one or two channels of the second set of channels, wherein each channel in the second set of channels is an adjacent channel to one or two channels of the first set of channels, wherein, for each channel of the first set of channels, the respective rotated beam provided by the channel is of the fourth polarization, and wherein, for each channel of the second set of channels, the respective rotated beam provided by the channel is of the fifth polarization.

The phrase “adjacent channel” may refer to an “adjacent channel” as described above.

The fourth and fifth polarization direction may be different form each other and/or may be different from the first polarization direction.

The fourth and fifth polarization direction may be equal to the second and third polarization direction, respectively.

The two or more channels may be grouped into two groups associated with different polarizations. The two or more channels may consist of the first set of channels and the second set of channels.

In a further implementation form of the first aspect, each channel further comprises a polarized transmitter segment, wherein the optical isolator segment is positioned between the polarized transmitter segment and the multiplexer, and/or wherein the third rotator segment is positioned between the polarized transmitter segment and the optical isolator segment.

In a further implementation form of the first aspect, for each channel, a polarization direction of the polarized transmitter segment matches the first polarization direction, and/or, for each channel, the polarized transmitter segment is configured to receive one input beam of the two or more input beams and provide the input beam to the optical isolator segment or the third rotator segment.

In a further implementation form of the first aspect, the multiplexer is a wavelength multiplexer and/or a polarization multiplexer, and wherein the multiplexer is configured to combine all of the rotated beams that are provided by the two or more channels to the multiplexer.

In a further implementation form of the first aspect, each rotator segment comprises a faraday rotator, and/or wherein each optical isolator segment comprises a faraday rotator.

For example, each first, second, and/or third rotator segment may comprise a faraday rotator.

The polarization of the respective beams of each channel are rotated based on the non-isotropic properties of the faraday rotator, which may be a faraday magnetic rotator.

Each faraday magnetic rotator may be combined with linear polarizers and free space multiplexing filters.

A second aspect of this disclosure provides a method of operating an optical device for wavelength division multiplexing of two or more input beams, wherein the optical device comprises a multiplexer and two or more channels for the two or more input beams, wherein the method comprises: receiving, with each channel, one input beam of the two or more input beams, providing, with each channel, a rotated beam, which has a polarization rotated compared to a polarization of the corresponding input beam, to the multiplexer, and rotating, with at least one channel of the two or more channels, the polarization of the corresponding input beam in a different direction than at least one other channel of the two or more channels.

The method of the second aspect may have implementation forms that correspond to the implementation forms of the device of the first aspect. The method of the second aspect and its implementation forms achieve the advantages and effects described above for the device of the first aspect and its respective implementation forms.

In this disclosure the phrase “linear polarizer” and “linear polarization filter” may be used interchangeably.

Further, in this disclosure the phrases “SOP”, “polarization direction”, “polarization”, and “direction” when referring to polarization may be used interchangeably.

Further, in this disclosure each respective beam of a channel of the two or more channels may be based on the input beam of the channel. For example, the respective beam of a channel may be the input beam of the channel or a modified input beam that was modified by other segments of the channel.

Further, in this disclosure, for each channel, the respective beam of the channel may be considered to be the same respective beam of the channel after being modified or influenced by any segment or optical component mentioned above, for example, any polarizer segment mentioned above, any isolator segment mentioned above, any rotator segment mentioned above, or any polarized transmitter segment mentioned above.

Further, in this disclosure, for each channel, the rotated beam, the first rotated beam, the second rotated beam, and/or the third rotated beam may refer to different variants or versions of the same respective beam of the channel.

Further, in this disclosure, for each channel, the respective beam of the channel may comprise the rotated beam and may further comprise at least one of the first rotated beam, the second rotated beam, and/or the third rotated.

Further, in this disclosure, for each channel, the rotated beam, the first rotated beam, the second rotated beam, and/or the third rotated beam may be parts of the respective beam of the channel.

Further, in this disclosure, for each channel, the rotated beam, the first rotated beam, the second rotated beam, and/or the third rotated beam may be modified versions of and/or based on the input beam of the channel.

Further, in this disclosure, for each channel, after being modified by a polarizer, for example the first polarizer or the second polarizer, the rotated beam, the first rotated beam, the second rotated beam, and/or the third rotated beam may be considered to be respectively the rotated beam, the first rotated beam, the second rotated beam, and/or the third rotated beam.

Further, in this disclosure, for each channel, the phrases “before” and “after” may be defined in reference to a path along the channel from the segments of the channel that are configured to receive the input beam of the channel to segments of the channel that are configured to provide the rotated beam to the multiplexer.

It has to be noted that all devices, elements, units and means described in the disclosure could be implemented in the software or hardware elements or any kind of combination thereof. All steps which are performed by the various entities described in the disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows an optical device according to an embodiment of this disclosure.

FIG. 2 shows an optical device further comprising an isolator segment according to an embodiment of this disclosure.

FIG. 3 shows an optical device further comprising additional segments according to an embodiment of this disclosure.

FIG. 4 shows an exemplary optical isolator segment according to an embodiment of this disclosure.

FIG. 5 shows an exemplary optical device according to an embodiment of this disclosure, wherein the respective beams of adjacent channels have orthogonal SOPs of 45° and −45°.

FIG. 6 shows an exemplary optical device and exemplary SOPs of the respective beams of each channel according to an embodiment of this disclosure.

FIG. 7 shows a method according to an embodiment of this disclosure.

### DETAILED DESCRIPTION OF EMBODIMENTS

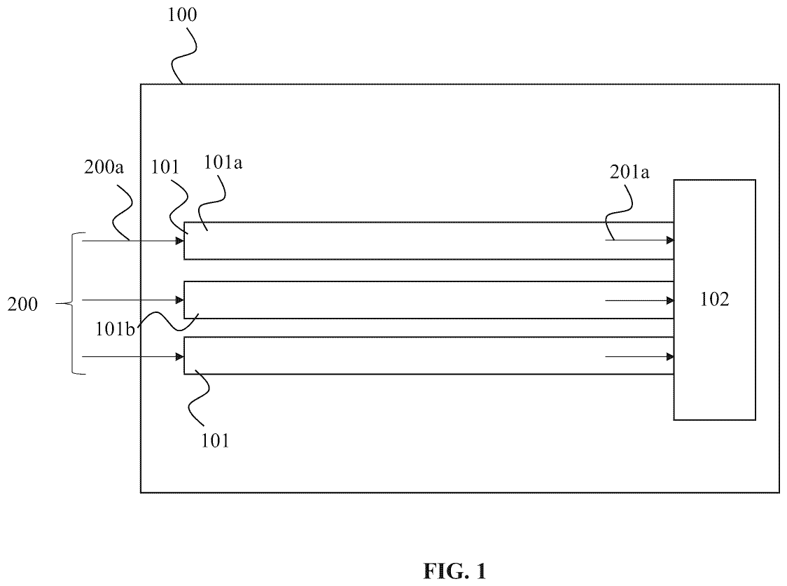

FIG. 1 shows an optical device 100 according to an embodiment of this disclosure. The optical device 100 comprises a multiplexer 102 and two or more channels 101 for two or more input beams 200. Each channel 101 is configured to receive one input beam 200a of the two or more input beams 200 and to provide a rotated beam 201a, which has a polarization rotated compared to a polarization of the corresponding input beam 200a, to the multiplexer 102. At least one channel 101a of the two or more channels 101 is configured to rotate the polarization of the corresponding input beam 200a in a different direction than at least one other channel 101b of the two or more channels 101.

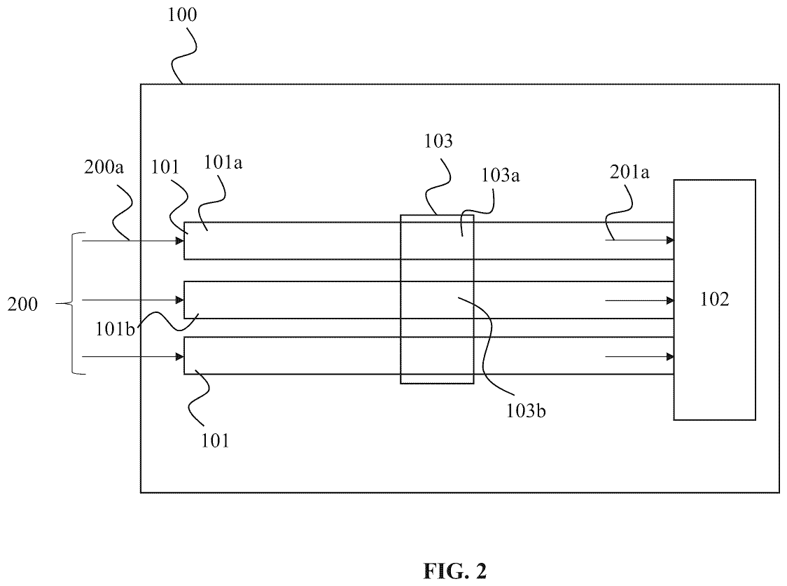

FIG. 2 shows an optical device 100 further comprising two or more optical isolator segments 103, wherein each channel 101a, 101b comprises respectively one optical isolator segment 103a, 103b of the two or more optical isolator segments 103.

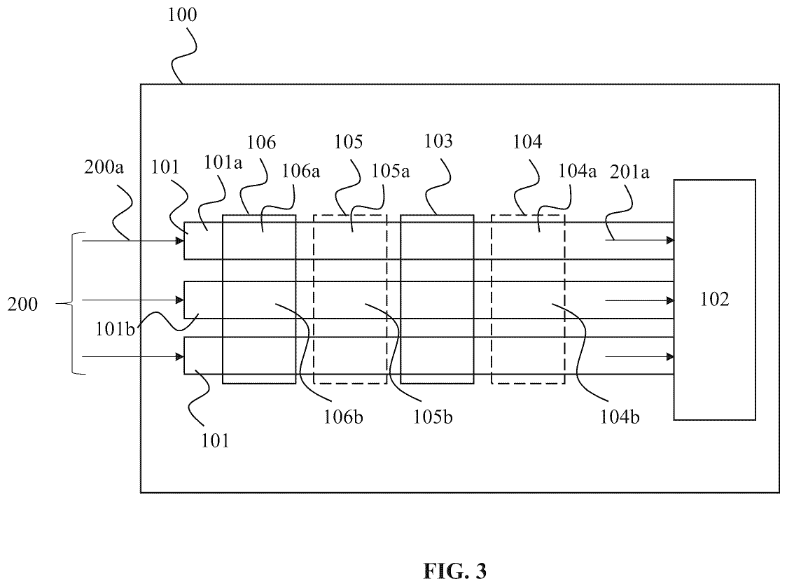

FIG. 3 shows an exemplary optical device 100, wherein said device may further comprise two or more second rotator segments 104, wherein each channel 101a, 101b may comprise respectively one second rotator segment 104a, 104b. Further, FIG. 3 shows that the optical device 100 may further comprise two or more third rotator segments 105, wherein each channel 101a, 101b may comprise respectively one third rotator segment 105a, 105b. Further, FIG. 3 shows that the optical device 100 may further comprise two or more polarized transmitter segments 106, wherein each channel 101a, 101b may comprise respectively one polarized transmitter segment 106a, 106b.

The optical device 100 may comprise either the two or more third rotator segments 105 or the two or more second rotator segments 104. Alternatively, the optical device 100 may comprise both the two or more third rotator segments 105 and the two or more second rotator segments 104.

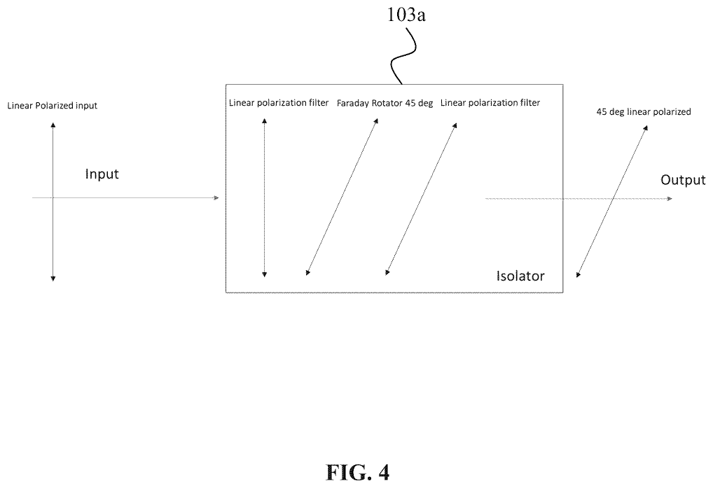

FIG. 4 shows an exemplary optical isolator segment 103a according to an embodiment of this disclosure. The optical isolator segment 103a may comprise a first linear polarization filter, a faraday rotator and a second linear polarization filter. Further, FIG. 4 shows that the optical isolator segment 103a may be configured to receive a linear polarized input beam with a polarization in an exemplary first direction. The first linear polarization filter may be configured to primarily transmit beams of said first polarization direction. Thus, the input beam may be minimally attenuated by the first linear polarization filter. After being transmitted by the first linear polarization filter the beam polarization may be rotated with the faraday rotator by 45° and may form a first rotated beam 201a. The second linear polarization filter may be configured to primarily transmit beams of said by 45° rotated polarization direction. Thus, the first rotated beam 201a may be minimally attenuated by the second linear polarization filter and may be transmitted by the second linear polarization filter and form an output beam, for example a first rotated beam 201a, of the optical isolator segment 103a.

A reflection of said output beam of the optical isolator segment 103a from optical elements that are positioned after the optical isolator segment 103a or other opposite direction beams that enter the optical isolator segment 103a from the opposite direction than the two or more input beams may be transmitted and/or attenuated by the second linear polarization filter. Said transmitted beam would consequently have a SOP of the first rotated beam 201a and would be rotated by the faraday rotator by 45° in the same direction as the input beam even though the propagation of said beams is in the opposite direction. Thus, the transmitted beam would have after the faraday rotator a SOP that is orthogonal to the orientation of the first linear polarization filter and would be completely attenuated by the first linear polarization filter. Thus, each optical isolator segment 103a may be configured to restrict the optical transmission through the channel to a direction towards the multiplexer 102.

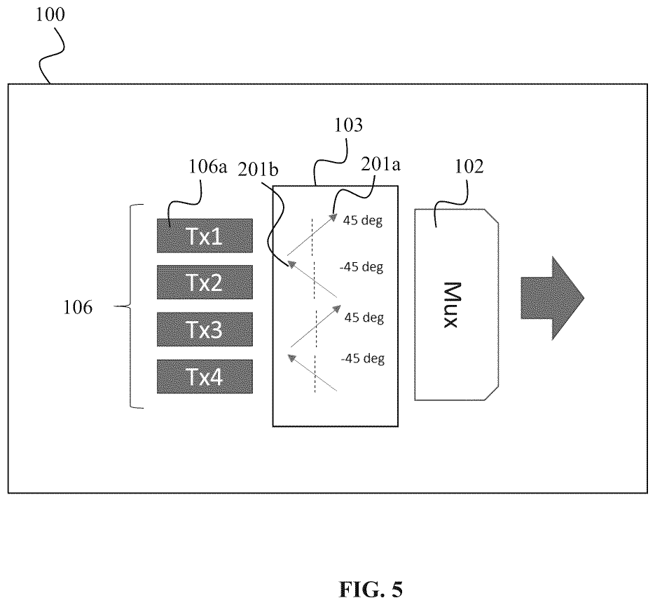

FIG. 5 shows an exemplary optical device 100 according to an embodiment of this disclosure, wherein the respective beams of adjacent channels have orthogonal SOPs of 45° and −45°. FIG. 5 shows four polarized transmitter segments 106, four optical isolator segments 103 and a multiplexer 102. The corresponding four channels 101 comprising the four polarized transmitter segments 106 and the four optical isolator segments 103 that are positioned adjacent to each other according FIG. 5 may form adjacent channels. For example, the input beams transmitted through the polarized transmitter segment Tx1 and Tx3 may have a respectively next largest and next smallest wavelength of the two or more input beams 200 to the input beam transmitted through the polarized transmitter segment Tx2. Thus, FWM during multiplexing in the multiplexer 102 may be minimized, as the respective rotated beams 201a, 201b of adjacent channels after the four isolator segments may have orthogonal SOPs.

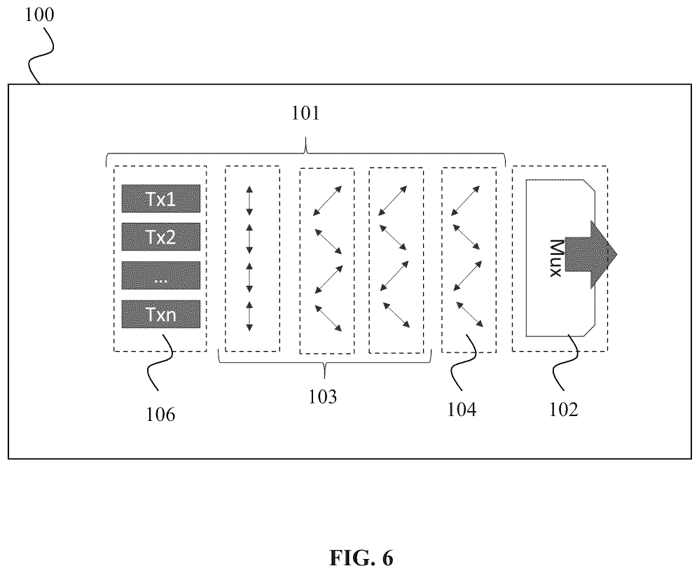

FIG. 6 shows an exemplary optical device 100 and exemplary SOPs of the respective beams of each channel 101a, 101b according to an embodiment of this disclosure. The optical device 100 comprises a multiplexer 102 and two or more channels 101 comprising two or more polarized transmitter segments 106, two or more optical isolator segments 103, and two or more second rotator segments 104. Each channel of the two or more channels 101 comprises the following five segments:
1. A linear polarized transmitter 106, wherein each input beam of the two or more input beams 200 transmitted by each polarized transmitter 106a, 106b may have a different wavelength and a same SOP.
2. A first linear polarizer, wherein the polarization angle of the first linear polarizer may be a first polarization direction and may match the polarization angle of the polarized transmitter, for example the SOP of the respective input beam.
3. A rotator segment for rotating the SOP of the respective beam of the channel by +/−45° polarization with respect to the respective first polarization direction of the channel to form a respective first rotated beam, wherein the respective first rotated beams of neighbouring channel have an orthogonal SOP.
4. A second linear polarizer, wherein the polarization angle of the second linear polarizer is aligned with the respective SOP of the respective first rotated beam of the channel 101a.
5. A second rotator segment 104a, wherein in this example the second rotator segment 104a only slightly rotates or does not rotate the SOP of the respective beam of the channel 101a.

The multiplexer 102, for example a wavelength multiplexer 102, may be configured to combine the output beams, for example the rotated beams 201a, 201b, of the two or more channels 101.

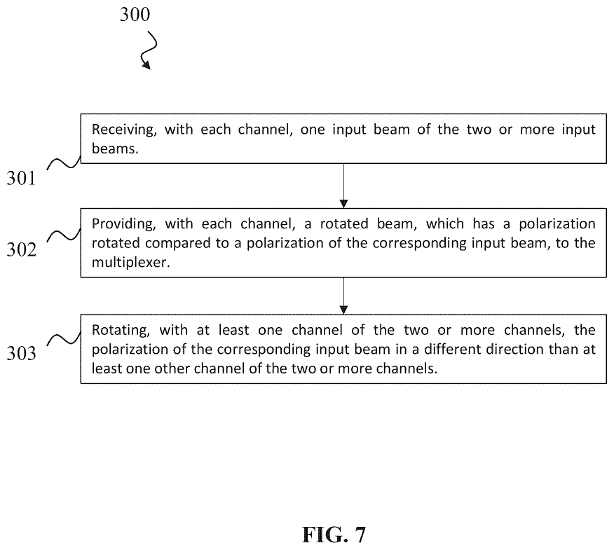

FIG. 7 shows a method 300 according to an embodiment of this disclosure. The method 300 may be performed by the optical device 100, wherein the optical device 100 comprises a multiplexer 102 and two or more channels 101 for two or more input beams. The method 300 comprises a step 301 of receiving, with each channel 101a, one input beam 200a of the two or more input beams. Further, the method 300 comprises a step 302 of providing, with each channel 101a, a rotated beam 201a, which has a polarization rotated compared to a polarization of the corresponding input beam 200a, to the multiplexer 102. Further, the method 300 comprises a step 303 of rotating, with at least one channel of the two or more channels 101, the polarization of the corresponding input beam 200a in a different direction than at least one other channel 101b of the two or more channels 101.

The disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. An optical device (100) for wavelength division multiplexing of two or more input beams (200),
wherein the optical device (100) comprises a multiplexer (102) and two or more channels (101) for the two or more input beams (200),
wherein each channel (101) is configured to receive one input beam (200a) of the two or more input beams (200) and to provide a rotated beam (201a), which has a polarization rotated compared to a polarization of the corresponding input beam (200a), to the multiplexer (102), and
wherein at least one channel (101a) of the two or more channels (101) is configured to rotate the polarization of the corresponding input beam (200a) in a different direction than at least one other channel (101b) of the two or more channels (101).

2. The optical device (100) according to claim 1,
wherein each channel (101) comprises an optical isolator segment (103) configured to restrict the optical transmission through the channel to a direction towards the multiplexer (102).

3. The optical device (100) according to claim 2,
wherein, for each channel (101), the optical isolator segment (103) comprises a rotator segment configured to rotate the polarization of a respective beam of the channel, and
wherein, for at least one channel (101a), the rotator segment is configured to rotate the respective beam of the channel in a different direction than the rotator segment of at least one other channel (101b) of the two or more channels (101).

4. The optical device (100) according to claim 3,
wherein each optical isolator segment (103) comprises a first polarizer segment and a second polarizer segment,
wherein, for each channel (101), the rotator segment is positioned between the first polarizer segment and the second polarizer segment, and wherein the second polarizer segment is positioned between the rotator segment and the multiplexer (102),
wherein, for each channel (101), the rotator segment is configured to rotate the polarization of the respective beam of the channel to form a first rotated beam,
wherein each first polarizer segment comprises a linear polarizer configured to primarily transmit beams of a first polarization direction, and
wherein each second polarizer segment comprises a linear polarizer configured to primarily transmit beams with a polarization of the respective first rotated beam of the channel.

5. The optical device (100) according to claim 3,
wherein each channel (101) further comprises a second rotator segment (104),
wherein the second rotator segment (104) is positioned between the multiplexer (102) and the optical isolator segment (103), and
wherein the second rotator segment (104) is configured to rotate the polarization of the respective beam of the channel.

6. The optical device (100) according to claim 4,
wherein, for each channel (101), the respective first rotated beam is the rotated beam provided by the channel, or
wherein, for each channel (101), the second rotator segment (104) is configured to rotate the polarization of the respective beam of the channel to form a second rotated beam, and
wherein, for each channel (101), the respective second rotated beam is the rotated beam provided by the channel.

7. The optical device (100) according to claim 2,
wherein each channel (101) further comprises a third rotator segment (105),
wherein the optical isolator segment (103) is positioned between the third rotator segment (105) and the multiplexer (102), and
wherein the third rotator segment (105) is configured to rotate the polarization of the respective beam of the channel into the first polarization direction.

8. The optical device (100) according to claim 1, wherein the two or more input beams (200) have a same polarization.

9. The optical device (100) according to claim 1,
wherein each input beam of the two or more input beams (200) has a different central wavelength.

10. The optical device (100) according to claim 9,
wherein each channel (101) is associated with a central wavelength of the corresponding input beam of the channel,
wherein each channel (101) forms an adjacent channel with one or two other channels that is associated with an input beam with a next larger or next smaller central wavelength of the two or more input beams (200).

11. The optical device (100) according to claim 10,
wherein, for each channel (101), the rotator segment is configured to rotate the polarization of the respective beam of the channel in a different direction than the rotator segment of the one or two adjacent channels of the channel.

12. The optical device (100) according to claim 11,
wherein, for each channel (101), the rotator segment is configured to rotate the polarization of the respective beam of the channel in a different direction than the rotator segment of the one or two adjacent channels of the channel such that the respective rotated beams provided by adjacent channels have orthogonal polarizations to each other.

13. The optical device (100) according to claim 11,
wherein, for each channel (101), the rotator segment is configured to rotate the polarization of the respective beam of the channel by a same absolute amount but in a different direction than the rotator segment of the one or two adjacent channels of the channel.

14. The optical device (100) according to claim 13,
wherein, for each channel (101), the rotator segment is configured to rotate the polarization of the respective beam of the channel by 45° in a first plane and rotator segments of the one or two adjacent channels of the channel are configured to rotate the polarization of the respective beam of the channel by −45° in the first plane.

15. The optical device (100) according to claim 10,
wherein, for each channel (101), the rotator segment of the optical isolator segment (103) is configured to rotate the polarization of the respective beam of the channel by a maximum absolute amount that fulfils the condition that the respective rotated beams provided by adjacent channels are orthogonal to each other.

16. The optical device (100) according to claim 10,
wherein each channel (101) is configured to rotate the polarization of the corresponding input beam into a second direction that is orthogonal to a third direction, and
wherein the third direction is the direction of polarization of the respective rotated beams provided by the one or two adjacent channels of the channel.

17. The optical device (100) according to claim 1,
wherein each rotated beam provided by the two or more channels (101) to the multiplexer (102) is either of a fourth polarization or a fifth polarization, wherein the fourth polarization is orthogonal to the fifth polarization.

18. The optical device (100) according to claim 10,
wherein the two or more channels (101) comprise a first set of channels and a second set of channels,
wherein each channel (101) in the first set of channels is an adjacent channel to one or two channels of the second set of channels,
wherein each channel (101) in the second set of channels is an adjacent channel to one or two channels of the first set of channels,
wherein, for each channel (101) of the first set of channels, the respective rotated beam provided by the channel is of the fourth polarization, and
wherein, for each channel (101) of the second set of channels, the respective rotated beam provided by the channel is of the fifth polarization.

19. The optical device (100) according to claim 1,
wherein each channel (101) further comprises a polarized transmitter segment (106),
wherein the optical isolator segment (103) is positioned between the polarized transmitter segment (106) and the multiplexer (102), and/or wherein the third rotator segment (105) is positioned between the polarized transmitter segment (106) and the optical isolator segment (103).

20. The optical device (100) according to claim 19,
wherein, for each channel (101), a polarization direction of the polarized transmitter segment (106) matches the first polarization direction, and/or
wherein, for each channel (101), the polarized transmitter segment (106) is configured to receive one input beam (200a) of the two or more input beams (200) and provide the input beam to the optical isolator segment (103) or the third rotator segment (105).

21. The optical device (100) according to claim 1,
wherein the multiplexer (102) is a wavelength multiplexer (102) and/or a polarization multiplexer (102), and
wherein the multiplexer (102) is configured to combine all of the rotated beams that are provided by the two or more channels (101) to the multiplexer (102).

22. The optical device (100) according to claim 1,
wherein each rotator segment comprises a faraday rotator, and/or
wherein each isolator segment (103) comprises a faraday rotator.

23. A method (300) for operating an optical device (100) for wavelength division multiplexing of two or more input beams (200),
wherein the optical device (100) comprises a multiplexer (102) and two or more channels (101) for the two or more input beams (200),
wherein the method comprises:
receiving (301), with each channel (101), one input beam (200a) of the two or more input beams (200),
providing (302), with each channel (101), a rotated beam, which has a polarization rotated compared to a polarization of the corresponding input beam (200a), to the multiplexer (102), and
rotating (303), with at least one channel (101a) of the two or more channels (101), the polarization of the corresponding input beam (200a) in a different direction than at least one other channel (101b) of the two or more channels (101).
